(19) United States
(12) Patent Application Publication
(10) Pub. No.: US 2008/0080719 A1
(43) Pub. Date: Apr. 3, 2008

(54) Stereo support system and method for mobile terminal

(75) Inventors: Kyung Hwan Ahn, Daegu Metropolitan City (KR); Kyong Hun Lee, Cheongwon-gun (KR); Yong Ju Kim, Gumi-si (KR); Seung Chul Choi, Daegu Metropolitan City (KR); Tae Seop Han, Gumi-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/901,590

(22) Filed: Sep. 18, 2007

(30) Foreign Application Priority Data
Oct. 2, 2006 (KR) 2006-0097172

(51) Int. Cl. H04R 31/00

(52) U.S. Cl. 381/17

(57) ABSTRACT

A stereo support system and method for a mobile terminal are disclosed. The stereo support method uses a sound generation device having a sound generation main unit and a sound generation sub-unit to play a first audio material selected in a mobile terminal, and comprises: generating a second audio material by modifying phase or play-time properties of the first audio material; and streaming the first audio material to the sound generation main unit and the second audio material to the sound generation sub-unit. As a result, the user of a mobile terminal can enjoy stereo sounds using a monaural headset.

### CLAIMS OF PRIORITY

This application claims priority to an application entitled “STEREO SUPPORT SYSTEM AND METHOD FOR MOBILE TERMINAL,” filed in the Korean Intellectual Property Office on Oct. 2, 2006 and assigned Serial No. 2006-0097172, the contents of which are incorporated herein by reference.

### BACKGROUND OF THE INVENTION

1. Field of the Invention

The present invention relates generally to a mobile terminal and, more particularly, to a stereo support system and method for a mobile terminal, wherein audio signals are separately sent to left and right units of a monaural headset to produce the surrounding stereo sound effects.

2. Description of the Related Art

An advance in mobile terminal enables a user to process a phone call and message as well as in supporting diversified functions, such as storing and reproducing user information, playing MPEG-1 Audio Layer 3 (MP3) audio files, receiving digital multimedia broadcasting (DMB), displaying moving images, and photographing.

Often, the additional function allows a mobile terminal to produce sounds in conjunction with the display of visual images. However, sounds through a speaker for a particular user may be regarded as a noise for nearby persons. To this end, an earphone or a headset enables the user to listen to sounds from the mobile terminal without causing annoyance to others.

In a popular conventional monaural headset, an identical audio signal is sent to left and right headset units. As a result, although a mobile terminal can provide high-quality stereo sounds, the user cannot enjoy the stereo sounds using the conventional monaural headset.

### SUMMARY OF THE INVENTION

The present invention has been made in view of the above problems and provides additional advantages, by providing a stereo support system and method for a mobile terminal which enable a monaural sound generation device, such as a headset, to produce stereo sounds.

In accordance with an exemplary embodiment of the present invention, a stereo support system includes: a mobile terminal for generating, by modifying phase or play-time properties of a first audio material pre-stored or externally sourced, a second audio material; and a sound generation device that has a sound generation main unit for playing the first audio material from the mobile terminal and a sound generation sub-unit for playing the second audio material.

In accordance with another exemplary embodiment of the present invention, there is provided a stereo support method using a sound generation device that has a sound generation main unit and a sound generation sub-unit to play a first audio material selected in a mobile terminal, the method including: generating a second audio material by modifying phase or play-time properties of the first audio material; and streaming the first audio material to the sound generation main unit and the second audio material to the sound generation sub-unit.

### BRIEF DESCRIPTION OF THE DRAWINGS

The above features and advantages of the present invention will be more apparent from the following detailed description in conjunction with the accompanying drawings, in which:

FIG. 1 is a diagram illustrating a stereo support system according to an exemplary embodiment of the present invention;

FIG. 2 illustrates a configuration of a mobile terminal in the system of FIG. 1;

FIG. 3 illustrates a configuration of a sound generation device in the system of FIG. 1;

FIG. 4 is a sequence diagram illustrating a procedure for providing a communication channel establishment in a stereo support method according to another exemplary embodiment of the present invention;

FIG. 5 is a sequence diagram illustrating a procedure for providing a stereo sound reproduction in the stereo support method;

FIG. 6 is a sequence diagram illustrating a procedure for a call process during a stereo sound reproduction in the stereo support method;

FIG. 7 is a sequence diagram illustrating of a procedure for terminating stereo sound reproduction in the stereo support method;

FIG. 8 is a flow chart illustrating the stereo support method; and

FIG. 9 is a state diagram illustrating operation mode transitions in the system of FIG. 1.

### DETAILED DESCRIPTION OF EXEMPLARY EMBODIMENTS

Hereinafter, exemplary embodiments of the present invention are described in detail with reference to the accompanying drawings. The same reference symbols identify the same or corresponding elements in the drawings. For the purposes of clarity and simplicity, detailed descriptions of constructions or processes known in the art may be omitted to avoid obscuring the invention in unnecessary detail. Particular terms may be defined to describe the invention in the best manner. Accordingly, the meaning of specific terms or words used in the specification and the claims should not be limited to the literal or commonly employed sense, but should be construed in accordance with the spirit of the invention. The description of the various embodiments is to be construed as exemplary only and does not describe every possible instance of the invention. Therefore, it should be understood that various changes may be made and equivalents may be substituted for elements of the invention.

In the description, a headset having a Bluetooth module is used, for illustrative purposes, to implement a stereo support system according to the teachings of the present invention. The stereo support system may also be implemented by means of any communication technology enabling short-range wireless communication, such as ZigBee or ultra wide band (UWB) technology.

In order to assist the understanding of the present invention, a brief summary of various communications schemes, to which the present invention is applied, will be explained hereinafter.

Bluetooth is a radio standard and communications protocol for short-range voice and data communication. Bluetooth provides a point-to-point connection or a point-to-multipoint connection, enables communication in the presence of obstacles, and covers a short-range of 10 cm-100 m. The Bluetooth protocol operates in the industrial, scientific and medical (ISM) band of 2.402 GHz to 2.480 GHz, and supports a data rate of 1 Mbps. A Bluetooth enabled device is a low power device that can operate at 0.3 mA during standby and at a maximum of 30 mA during data transfer. Bluetooth uses frequency hopping, which divides the band into 79 or 23 channels (each 1 MHz wide) and changes channels up to 1600 times per second, to reduce interference and fading. The lower guard band corresponds to a frequency band of 2.4-2.402 GHz (2 MHz wide), and the upper guard band corresponds to a frequency band of 2.480-2.4835 GHz (3.5 MHz wide). Bluetooth enabled devices are divided into three power classes: class 1 (maximum output power of 100 mW, with a range of up to 100 m), class 2 (maximum output power of 2.5 mW, with a range of up to 10 m), and class 3 (maximum output power of 1 mW, with a range of up to 1 m). Bluetooth uses gaussian frequency shift keying (GFSK) for modulation, and can support three voice channels carrying voice data encoded using A-law pulse-code modulation (PCM), μ-law PCM, or continuous variable slope delta modulation (CVSD).

ZigBee is a low data rate, two-way standard (IEEE 802.15.4) for home automation and data networks. A usage example of ZigBee is performance, with a single remote control, of home automation tasks such as turning on/off of lights, setting of a home security system, or turning on/off of a television set. With ZigBee, all these tasks can be performed from any place in the home at a touch of a remote control button. ZigBee also enables dial-in access via the Internet for home automation control. ZigBee operates in the ISM radio bands of 868 MHz, 915 MHz, and 2.4 GHz. ZigBee has a transmission range of 10 to 20 m, supports a data rate of 20-250 Kbps, and uses direct-sequence spread spectrum (DSSS) for modulation.

In the description, a mobile terminal and a sound generation device, such as a headset, communicate with each other through Bluetooth communication. Although a headset is described as a sound generation device, the sound generation device may be any device that can receive an audio signal and reproduce the received audio signal, such as a headset, wireless earpiece, or wireless speaker.

Although, for the purpose of description, a mobile communication terminal is described as an example of a mobile terminal of the present invention, the present invention is not limited to a mobile communication terminal. The mobile terminal of the present invention is a terminal having an interface to which a sound generation device is connected through wired or wireless communication, and may be any information and communication device or multimedia device, such as a mobile communication terminal, digital broadcast receiving terminal, personal digital assistant (PDA), smart phone, international mobile telecommunications 2000 (IMT 2000) terminal, wideband code division multiple access (WCDMA) terminal, universal mobile telecommunications system (UMTS) terminal, portable Internet terminal, or high-speed downlink packet access (HSDPA) terminal. Further, the mobile terminal may also be applied to applications using such devices.

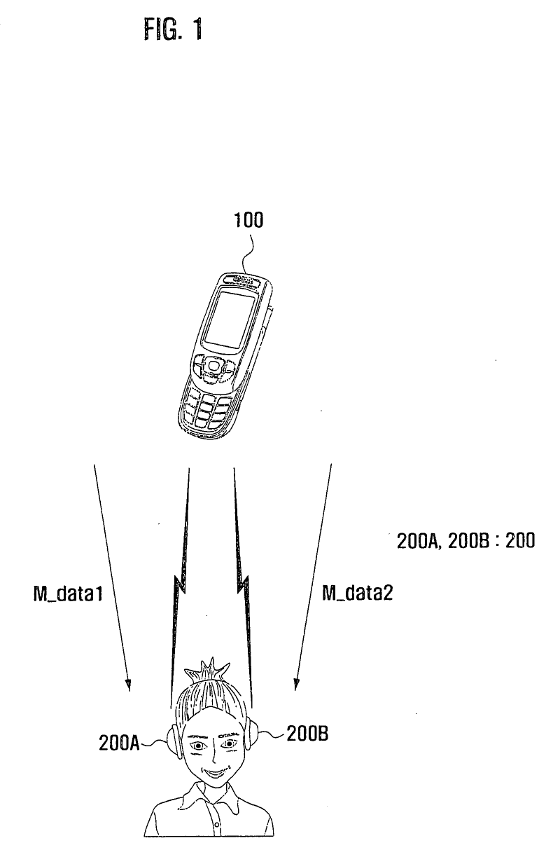

FIG. 1 illustrates a stereo support system according to an exemplary embodiment of the present invention.

Referring to FIG. 1, the stereo support system includes a mobile terminal 100 and a headset 200. The headset 200 includes a sound generation main unit 200A and a sound generation sub-unit 200B.

The mobile terminal 100 plays a first audio material (M_data1) stored in a memory unit through the sound generation main unit 200A of the headset 200, and also plays a second audio material (M_data2) through the sound generation sub-unit 200B. The second audio material is a time-delayed version or phase-shifted version of the first audio material. That is, the stereo support system generates stereo sounds by simultaneously playing an unmodified audio material and a time-delayed or phase-shifted version of the unmodified audio material.

The first audio material may be, for example, a radio broadcast received by the mobile terminal 100, or an audio file such as an MP3 file containing popular songs, learning materials, natural sounds and the like.

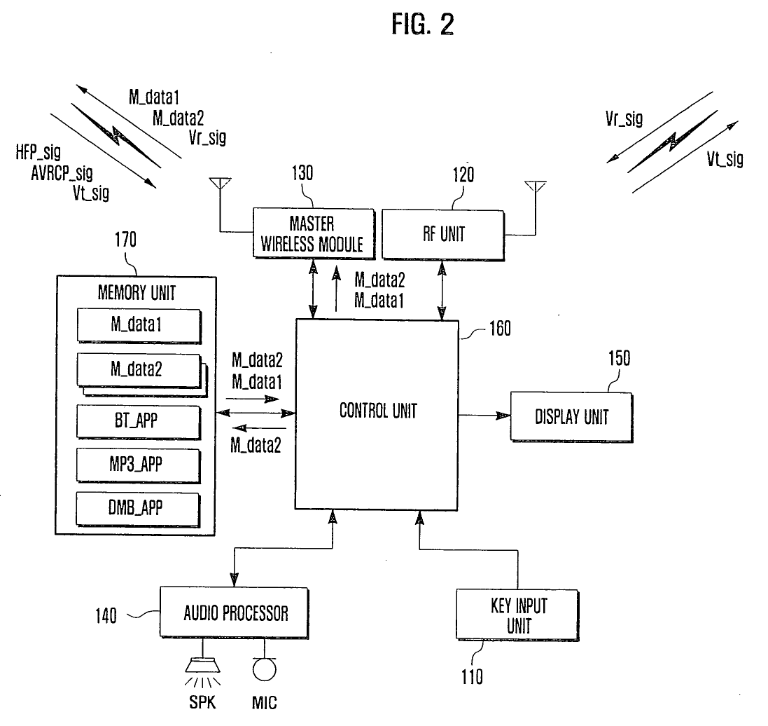

FIG. 2 illustrates a configuration of the mobile terminal 100 in the stereo support system.

Referring to FIG. 2, the mobile terminal 100 includes a master wireless module 130, memory unit 170, key input unit 110, display unit 150, audio processor 140, radio frequency (RF) unit 120, and control unit 160.

The master wireless module 130 may be a communication module for Bluetooth, ZigBee, ultra wideband, or infrared communication. A Bluetooth module is preferred for the master wireless module 130 in consideration of popularity.

The memory unit 170 stores an application program for stereo support, a Bluetooth application (BT_APP) for Bluetooth communication, an MP3 application (MP3_APP) for playing of MP3 audio data, and a digital multimedia broadcasting (DMB) application (DMB_APP) for digital broadcast reception. The memory unit 170 may include a program memory section and a data memory section.

The program memory section of the memory unit 170 stores an operating system for booting the mobile terminal 100, application programs for playing multimedia contents, application programs for supplementary functions related to a camera, audios, and still or moving images, and application programs for Bluetooth communication and DMB reception. When one of these functions is activated in response to a user request, the mobile terminal 100 executes a corresponding application program under the control of the control unit 160.

The data memory section of the memory unit 170 stores user data generated from the operation of the mobile terminal 100. The data memory section stores audio files, such as MP3 files, and video files. One of the stored audio files can be selected as a first audio material (M_data1) to be played through the sound generation main unit 200A of the headset 200, and can be processed into a second audio material (M_data2) to be played through the sound generation sub-unit 200B of the headset 200.

The first audio material (M_data1) can be an audio file. The second audio material (M_data2) is a time-delayed version or phase-shifted version of the first audio material (M_data1). When a second audio material is a phase-shifted version of a first audio material, simultaneous play of the first and second audio materials can produce the stereo sounds. When a second audio material is a time-delayed version of a first audio material, simultaneous play of the first and second audio materials can produce the stereo sounds. Further, to produce stereo sounds, a first audio material is played first, and a copy of the first audio material as a second audio material is played next with a preset time gap.

The key input unit 110 includes a plurality of alphanumeric and function keys for inputting alphanumeric information and setting various functions. The function keys may include direction, side, and shortcut keys associated with particular functions. The key input unit 110 sends a key signal, input by a user for setting and controlling the operations of the mobile terminal 100, to the control unit 160. In particular, the key input unit 110 sends a key signal for stereo support to the control unit 160. For example, when the mobile terminal 100 displays a menu of stereo support through the display unit 150 in response to a user request, the user selects a menu item in the displayed menu through the key input unit 110, and the key signal corresponding to the selected menu item is sent to the control unit 160.

The display unit 150 displays various menus of the mobile terminal 100, information input by the user and information to be provided to the user. In particular, the display unit 150 displays a menu for stereo support, a menu for utilization of the headset 200, and status information regarding connection between the master wireless module 130 of the mobile terminal 100 and the headset 200.

The audio processor 140 reproduces, through a speaker SPK, a first audio material corresponding to an MP3 audio file, to a DMB broadcast, or to a voice signal related to a phone call. In particular, when the headset 200 is not in use, the audio processor 140 reproduces a first audio material in the mobile terminal 100. During a stereo support mode, the audio processor 140 is disabled.

The RF unit 120 performs the communication operations related to wireless transmission of user data to and from another mobile terminal, and to access to an external Web server for the reception of a digital content. The RF unit 120 includes an RF transmitter for upconverting the frequency of a signal to be transmitted and amplifying the signal, and an RF receiver for low-noise amplifying a received signal and downconverting the frequency of the signal. In particular, the RF unit 120 may establish a call connection to a mobile communication system, and such a call connection is established or terminated according to a call control signal (HFP_sig) from the sound generation main unit 200A of the headset 200.

The control unit 160 controls the overall operation of the mobile terminal 100 and signal exchange between internal elements thereof. If the mobile terminal 100 is a mobile communication terminal, the control unit 160 may include a modulator/demodulator (modem) and a coder/decoder (codec).

In particular, for stereo support, the control unit 160 controls the establishment of communication channels between the master wireless module 130 and the sound generation main unit 200A of the headset 200, and between the master wireless module 130 and the sound generation sub-unit 200B. Thereafter, the control unit 160 streams a first audio material and a second audio material through the corresponding communication channels to the sound generation main unit 200A and the sound generation sub-unit 200B, respectively, using frequency hopping to avoid signal interference.

In response to an incoming call during the stereo support mode, the control unit 160 controls the establishment of a call connection, and then controls audio connection transfer, and transmission of an outgoing voice signal (Vt_sig) and reception of an incoming voice signal (Vr_sig). During the call, the control unit 160 can stop or suspend the streaming of a first audio material and second audio material to the headset 200, and resume streaming of the first audio material and second audio material after termination of the call.

In a non-stereo support mode, the control unit 160 may supply an identical first audio material to both the sound generation main unit 200A and sound generation sub-unit 200B of the headset 200, producing monaural sounds.

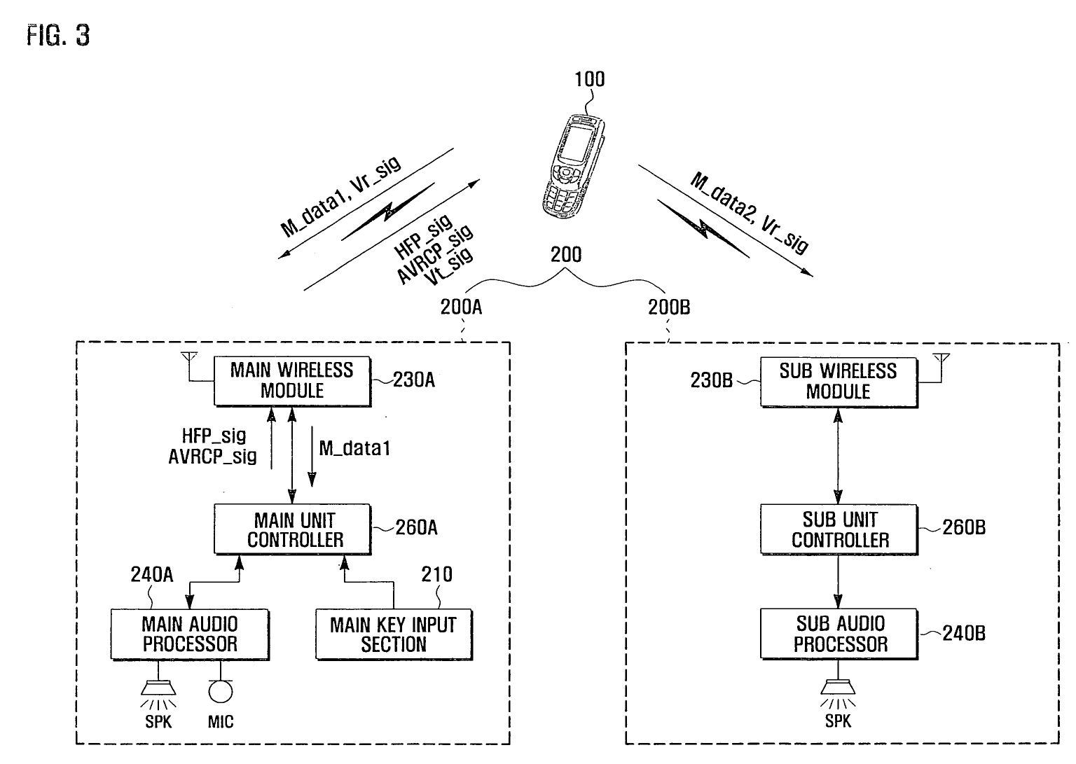

FIG. 3 illustrates a configuration of the headset 200.

Referring to FIG. 3, the headset 200 includes a sound generation main unit 200A and a sound generation sub-unit 200B. The sound generation main unit 200A includes a main wireless module 230A, main audio processor 240A, main key input section 210, and main unit controller 260A. The sound generation sub-unit 200B includes a sub wireless module 230B, sub audio processor 240B, and sub unit controller 260B.

The main wireless module 230A preferably supports the same short-range wireless communication as that of the master wireless module 130 in the mobile terminal 100. The main wireless module 230A and the master wireless module 130 may each include either a Bluetooth module or a ZigBee module.

In Bluetooth communication, the main wireless module 230A and the master wireless module 130 form a Bluetooth piconet on a common wireless channel. The main wireless module 230A receives data through the piconet from the master wireless module 130 and transmits a play control signal for controlling the mobile terminal 100 thereto.

The main wireless module 230A communicates with the master wireless module 130 through a synchronous connection-oriented (SCO) link, to transmit an outgoing voice signal (Vt_sig) to the master wireless module 130 and to receive an incoming voice signal (Vr_sig) therefrom, and to receive a streaming audio material (for example, M_data1).

The main wireless module 230A also communicates with the master wireless module 130 through an asynchronous connection-less (ACL) link to transmit a remote control command signal (AVRCP_sig) for control of the mobile terminal 100 (for example, fast forward, rewind, repeat, continuous repeat, selection or random selection) in connection with the playing of a first audio material, and to transmit a call control signal (HFP_sig) for call connection establishment, under the control of the main unit controller 260A.

The sub wireless module 230B of the sound generation sub-unit 200B receives an incoming voice signal (Vr_sig) associated with a call from the master wireless module 130 through an SCO link, and receives an audio signal associated with a second audio material (M_data2) for stereo support through an SCO link, under the control of the sub unit controller 260B.

The main audio processor 240A reproduces, through a speaker, an incoming voice signal and an audio signal associated with a first audio material from the master wireless module 130, and collects an outgoing voice signal through a microphone. The sub audio processor 240B reproduces, through a speaker, an incoming voice signal and an audio signal associated with a second audio material from the master wireless module 130. The sub audio processor 240B may have no microphone.

The main key input section 210 is used to generate a key input signal for the reception of an audio signal associated with a first audio material from the master wireless module 130, to generate a call control signal (HFP_sig) according to a call control decision in response to a call connection request from the master wireless module 130, to generate a remote control command signal (AVRCP_sig) for play control of the first audio material, and to send the generated signals to the master wireless module 130. The sound generation sub-unit 200B may further include a sub key section (not shown) similar to the main key input section 210. The sound generation main unit 200A and sound generation sub-unit 200B may each include a volume adjustment input key.

In the sound generation main unit 200A, the main unit controller 260A controls the reception of an audio signal associated with a first audio material from the master wireless module 130, and controls transmission of a remote control command signal for play control of a first audio material to the master wireless module 130. The main unit controller 260A also controls the transmission of a call control signal for call connection to another mobile terminal, and transmission of an outgoing voice signal (Vt_sig) and the reception of an incoming voice signal (Vr_sig) via the master wireless module 130.

In the sound generation sub-unit 200B, the sub unit controller 260B controls the reception of an audio signal associated with a second audio material from the main wireless module 230A and the reception of an incoming voice signal (Vr_sig) during a call.

The mobile terminal 100 may include other elements, for example a camera module and a multimedia module, in addition to the elements shown in FIGS. 2 and 3.

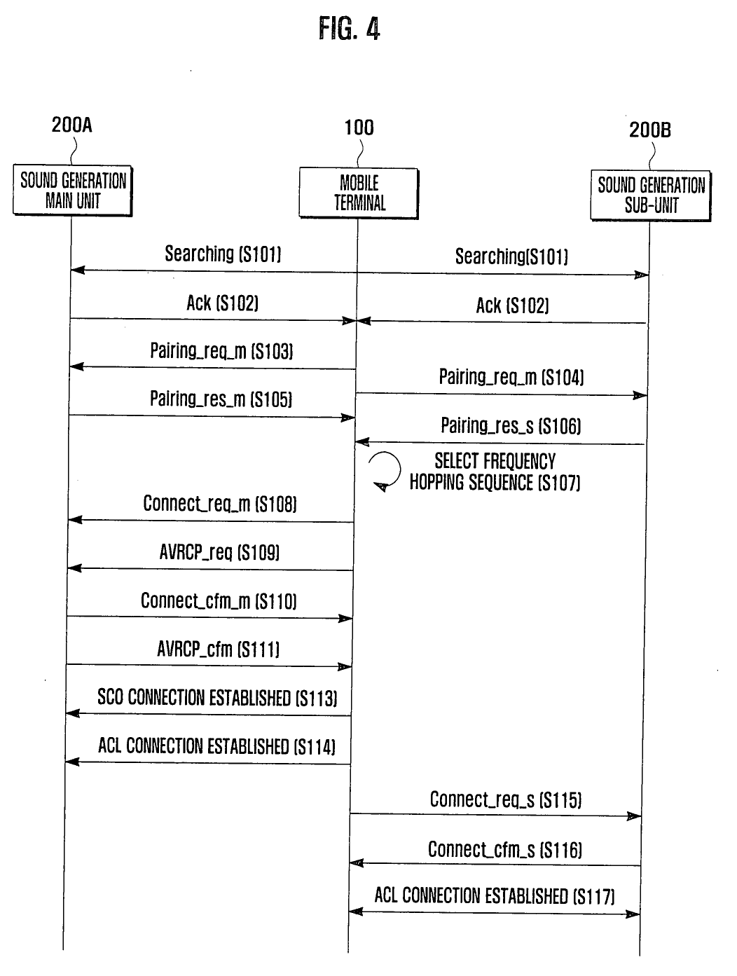

FIG. 4 is a sequence diagram illustrating a procedure for establishing a communication channel between the mobile terminal 100 and the headset 200 in the stereo support method.

Referring to FIG. 4, the control unit 160 of the mobile terminal 100 controls the master wireless module 130 to broadcast an inquiry message (Searching) to discover the sound generation main unit 200A and sound generation sub-unit 200B of the headset 200 (S101). In reply to the broadcast inquiry message, the sound generation main unit 200A and sound generation sub-unit 200B each transmit an acknowledgement message (Ack) to the mobile terminal 100 (S102).

The mobile terminal 100 transmits a pairing request message (Pairing_req_m) to the sound generation main unit 200A (S103), and transmits another pairing request message (Pairing_req_s) to the sound generation sub-unit 200B (S104). The sound generation main unit 200A transmits a pairing response message (Pairing_res_m) to the mobile terminal 100 (S105), and the sound generation sub-unit 200B transmits a pairing response message (Pairing_res_s) to the mobile terminal 100 (S106). After the reception of the pairing response messages, the control unit 160 of the mobile terminal 100 completes the pairing process, and selects a frequency hopping sequence for data transmission to the sound generation main unit 200A and the sound generation sub-unit 200B (S107).

For a communication channel setup, the mobile terminal 100 transmits an audio connection request message (Connect_req_m) to the sound generation main unit 200A (S108), and also transmits a remote control connection request message (AVRCP_req) (S109). In return, the sound generation main unit 200A transmits a connection acknowledgement message (Connect_cfm_m) to the mobile terminal 100 (S110), and also transmits a remote control connection acknowledgement message (AVRCP_cfm) (S111).

The mobile terminal 100 establishes an SCO connection to the sound generation main unit 200A for audio data transmission (S113), and also establishes an ACL connection for remote control command transmission (S114).

An SCO link is characterized by a periodic single-slot packet assignment (as data transmitted over an SCO link is only single-slot packets), and provides a symmetric full duplex channel supporting a data rate of 64 Kbps in each direction. The SCO link is a circuit-switched connection and is mainly used for voice transmission.

An ACL link provides a packet-switched connection and can support asymmetric data rates of 721 Kbps in one direction and 57.6 kbps in the other direction. Data transmitted over an ACL link is one to five slot packets.

Thereafter, the mobile terminal 100 transmits an audio connection request message (Connect_req_s) to the sound generation sub-unit 200B (S115). In return, the sound generation sub-unit 200B transmits a connection acknowledgement message (Connect_cfm_s) to the mobile terminal 100 (S116). The mobile terminal 100 establishes an ACL connection to the sound generation sub-unit 200B for audio data transmission in relation to the playing of a second audio material (S117).

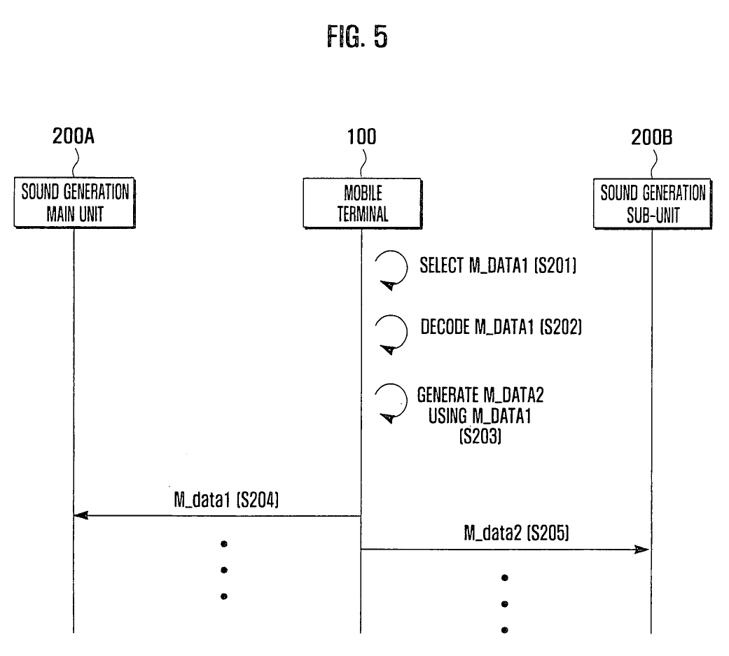

FIG. 5 is a sequence diagram illustrating a process for stereo sound reproduction in the stereo support method.

Referring to FIG. 5, in response to a play request from the user, the control unit 160 of the mobile terminal 100 selects a first audio material (M_data1) to be played (S201). The first audio material may be an audio file stored in the memory unit 170 such as an MP3 file containing popular songs, learning materials and natural sounds, or be a broadcast signal received by the mobile terminal 100 such as a radio broadcast, TV broadcast, DMB broadcast, digital audio broadcast, or digital video broadcast.

The control unit 160 decodes the selected first audio material (S202).

The control unit 160 generates a second audio material (M_data2) using the decoded first audio material for stereo support (S203), by modifying play-time or phase properties of the decoded first audio material, and storing the time-delayed or phase-shifted version as a second audio material. Simultaneous play of the first and second audio materials then can produce the stereo sounds.

The mobile terminal 100 streams the first audio material to the sound generation main unit 200A through an SCO connection (S204), and also streams the second audio material to the sound generation sub-unit 200B through an SCO connection (S205).

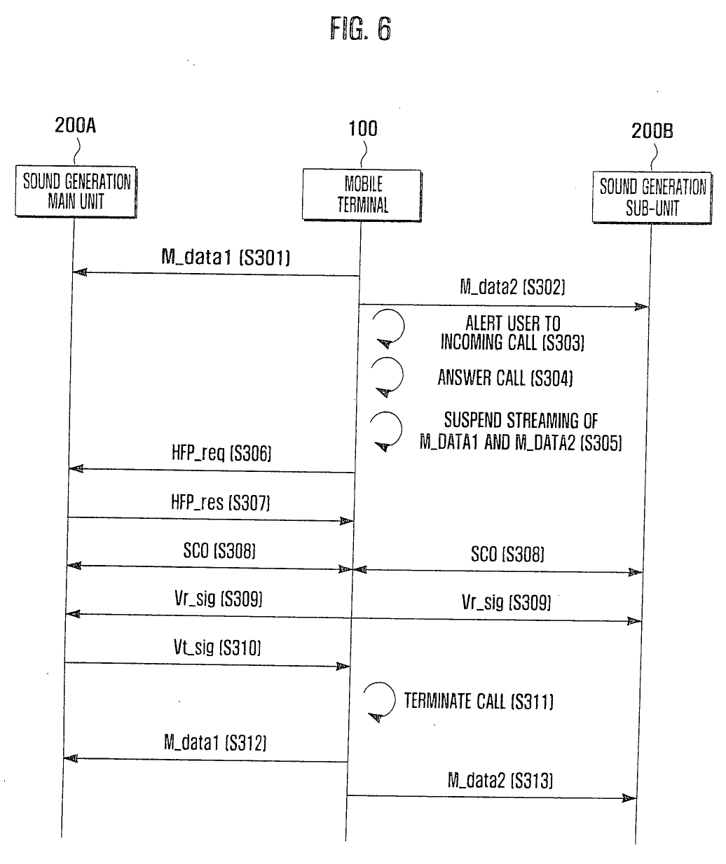

FIG. 6 is a sequence diagram illustrating a procedure for call processing during stereo sound reproduction in the stereo support method.

Referring to FIG. 6, in a stereo support mode, the mobile terminal 100 streams a first audio material (M_data1) to the sound generation main unit 200A of the headset 200 (S301), and also streams a second audio material (M_data2) to the sound generation sub-unit 200B (S302). Upon reception of an incoming call from another mobile terminal (S303), the mobile terminal 100 informs the user of the incoming call. If the user decides to answer the call (S304), the control unit 160 of the mobile terminal 100 suspends streaming of the first audio material and second audio material to the headset 200 (S305).

The mobile terminal 100 transmits a call control request message (HFP_req) to the sound generation main unit 200A (S306). In return, the sound generation main unit 200A transmits a call control confirm message (HFP_res) to the mobile terminal 100 (S307). The mobile terminal 100 establishes SCO connections to the sound generation main unit 200A and sound generation sub-unit 200B for voice signal transmission (S308), and transmits an incoming voice signal (Vr_sig) from the other mobile terminal to the sound generation main unit 200A and sound generation sub-unit 200B through the SCO connections (S309). The mobile terminal 100 transmits an outgoing voice signal (Vt_sig) collected by the sound generation main unit 200A to the other mobile terminal (S310). That is, the mobile terminal 100 transfers call control responsibility to the sound generation main unit 200A of the headset 200, and relays voice signals between the other mobile terminal and the headset 200.

Thereafter, when the call is terminated (S311), the control unit 160 of the mobile terminal 100 resumes the streaming of the first audio material and of the second audio material to the headset 200 (S312 and S313, respectively).

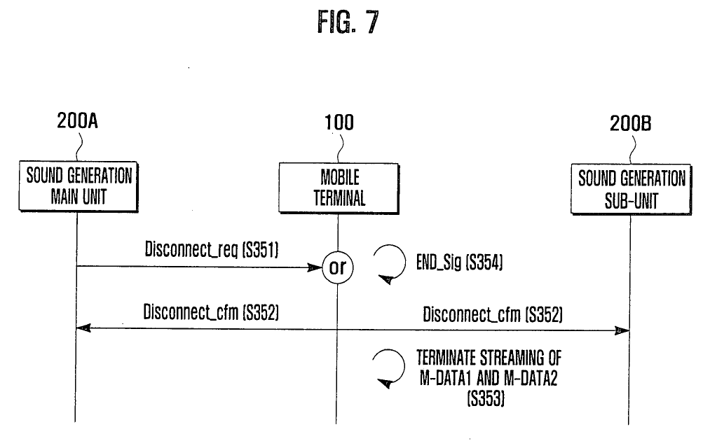

FIG. 7 is a sequence diagram illustrating a process for terminating stereo sound reproduction in the stereo support method.

Referring to FIG. 7, in response to the input of a stereo support termination command from the user through the main key input section 210, the sound generation main unit 200A of the headset 200 transmits a disconnect request message (Disconnect_req) to the mobile terminal 100 (S351). In return, the mobile terminal 100 transmits a disconnect confirm message (Disconnect_cfm) to the sound generation main unit 200A and the sound generation sub-unit 200B (S352), and terminates the streaming of a current first audio material and second audio material to the headset 200 (S353).

Alternatively, when a stereo support termination command (End_sig) is input from the user through the key input unit 110 (S354), the mobile terminal 100 transmits a disconnect confirm message (Disconnect_cfm) to the sound generation main unit 200A and the sound generation sub-unit 200B (S352), and terminates the streaming of a first audio material and second audio material to the headset 200 (S353).

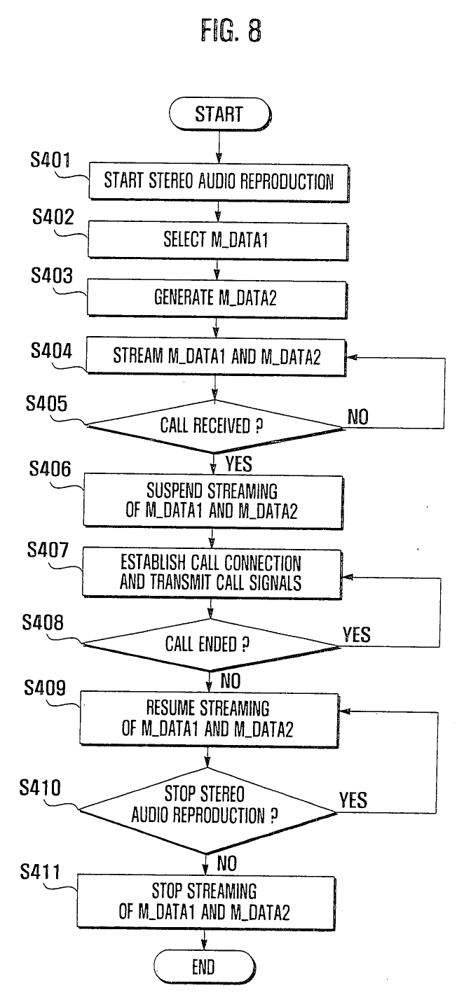

FIG. 8 is a flow chart illustrating the stereo support method according to another exemplary embodiment of the present invention.

Referring to FIG. 8, when the user inputs a select command for stereo audio reproduction (S401), the control unit 160 of the mobile terminal 100 selects a first audio material to be played (M_data1) from the memory unit 170 (S402). The control unit 160 generates a second audio material (M_data2) by modifying play-time or phase properties of the selected first audio material (S403).

In response to the input of a play command from the user, the mobile terminal 100 streams the first audio material to the sound generation main unit 200A of the headset 200, and also streams the second audio material to the sound generation sub-unit 200B (S404).

When an incoming call from another mobile terminal is received (S405), the mobile terminal 100 suspends the streaming of the first audio material and second audio material (S406), and makes a transition to the call processing mode. The mobile terminal 100 establishes a call connection between the other mobile terminal and the headset 200, forwards an incoming voice signal (Vr_sig) from the other mobile terminal to the sound generation main unit 200A and sound generation sub-unit 200B, and transmits an outgoing voice signal (Vt_sig) collected by the sound generation main unit 200A to the other mobile terminal (S407).

When the call is terminated (S408), the mobile terminal 100 makes a transition to the stereo support mode and resumes the streaming of the first audio material and second audio material (S409).

When a stop command is input from the user (S410), the mobile terminal 100 stops the streaming of a current first audio material and associated second audio material (S411).

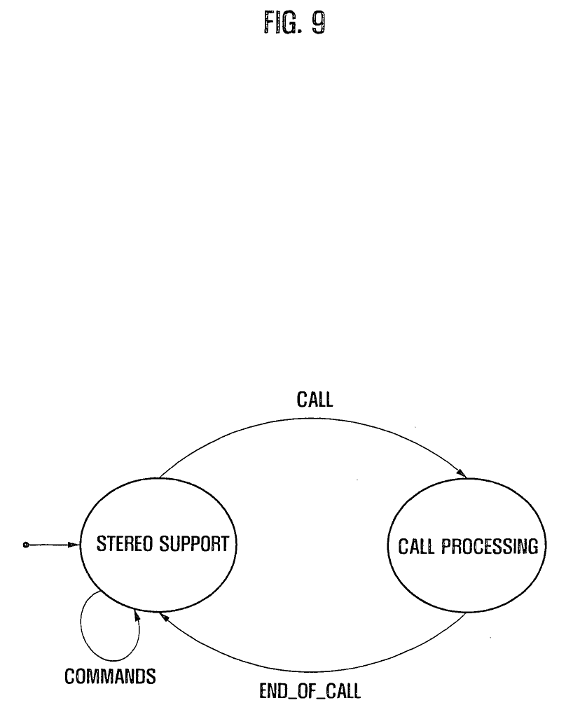

FIG. 9 is a state diagram illustrating operation mode transitions in the stereo support system of the present invention.

Referring to FIG. 9, the stereo support system can operate in a stereo support mode and a call processing mode, and normally operates in the stereo support mode.

In the stereo support mode, when the user inputs a select command for stereo audio reproduction, the control unit 160 of the mobile terminal 100 selects a first audio material to be played (M_data1) from the memory unit 170, and generates a second audio material (M_data2) by modifying play-time or phase properties of the selected first audio material.

In response to the input of a play command from the user, the mobile terminal 100 streams the first audio material to the sound generation main unit 200A of the headset 200, and also streams the second audio material to the sound generation sub-unit 200B.

When an incoming call from another mobile terminal is received, the mobile terminal 100 suspends the streaming of the first audio material and second audio material, and makes a transition to the call processing mode.

In the call processing mode, the mobile terminal 100 establishes a call connection between the other mobile terminal and the headset 200, forwards an incoming voice signal (Vr_sig) from the other mobile terminal to the sound generation main unit 200A and sound generation sub-unit 200B, and transmits an outgoing voice signal (Vt_sig) collected by the sound generation main unit 200A to the other mobile terminal. When the call is terminated, the mobile terminal 100 makes a transition to the stereo support mode, and resumes the streaming of the first audio material and second audio material.

In the stereo support mode, the mobile terminal 100 performs the necessary operations according to input of a play control command such as volume up/down or select. When a stop command is input from the user, the mobile terminal 100 stops the streaming of a current first audio material and associated second audio material.

As apparent from the above description, the present invention provides a stereo support system and method for a mobile terminal wherein a first audio material and a time-delayed or phase-shifted version of the first audio material are respectively streamed to two separate units of a monaural sound generation devices, such as a headset or earphone, thereby producing sounds in stereo.

While exemplary embodiments of the present invention have been shown and described in this specification, it will be understood by those skilled in the art that various changes or modifications of the embodiments are possible without departing from the spirit and scope of the invention as defined by the appended claims.

What is claimed is:

1. A stereo support method using a sound generation device having a sound generation main unit and a sound generation sub-unit to play a first audio material selected in a mobile terminal, the method comprising:
generating a second audio material by modifying phase or play-time properties of the first audio material; and
streaming the first audio material to the sound generation main unit and streaming the second audio material to the sound generation sub-unit.

2. The stereo support method of claim 1, wherein streaming timing of the first audio material is different from that of the second audio material by a preset time interval.

3. The stereo support method of claim 1, wherein the streaming step comprises:
establishing, by the mobile terminal, a connection-oriented communication channel to the sound generation main unit for the first audio material and another connection-oriented communication channel to the sound generation sub-unit for the second audio material; and
establishing, by the mobile terminal, a connectionless communication channel to the sound generation main unit for a remote control command for controlling a play of the first audio material.

4. The stereo support method of claim 1, further comprising:
suspending, in response to a reception of an incoming call, streaming of the first audio material and second audio material;
establishing a call connection under the control of the sound generation main unit; and
forwarding an incoming voice signal related to the incoming call to the sound generation device for sound generation, and transmitting an outgoing voice signal collected from a user to the mobile terminal.

5. The stereo support method of claim 1, further comprising:
establishing, in a response to reception of an incoming call, a connectionless communication channel to the sound generation main unit for call control by the sound generation main unit, and a connection-oriented communication channel to the sound generation main unit for voice transmission; and
establishing a connection-oriented communication channel to the sound generation sub-unit for voice transmission.

6. The stereo support method of claim 1, further comprising:
receiving a stereo support cancel request message from the sound generation main unit;
creating a stereo support cancel conform message;
transmitting the stereo support cancel conform message to the sound generation main unit and the sound generation sub-unit; and
terminating streaming of the first audio material and second audio material.

7. The stereo support method of claim 1, further comprising:
receiving, by a control unit of the mobile terminal, a stereo support cancel key signal input through a key input unit;
creating, by the control unit, a stereo support cancel conform message;
transmitting the stereo support cancel conform message to the sound generation main unit and the sound generation sub-unit; and
terminating streaming of the first audio material and second audio material.

8. A stereo support system comprising:
a mobile terminal for generating, by modifying phase or play-time properties of a first audio material pre-stored or externally sourced, a second audio material; and
a sound generation device having a sound generation main unit for playing the first audio material from the mobile terminal and a sound generation sub-unit for playing the second audio material.

9. The stereo support system of claim 8, wherein the mobile terminal comprises:
a master wireless module establishing short-range wireless channels to the sound generation main unit and the sound generation sub-unit;
a memory unit storing at least one audio material;
a key input unit generating a key signal to control audio streaming;
a radio frequency unit establishing a communication channel to a mobile communication network for call signal transmission and reception; and
a control unit for controlling signals exchanged between internal elements, communication channel establishment, and audio streaming, so as to produce stereo sounds through the sound generation main unit and sound generation sub-unit.

10. The stereo support system of claim 8, wherein the sound generation main unit comprises:
a main wireless module establishing a short-range wireless channel to the mobile terminal;
a main audio processor;
a main key input section generating a key signal to control audio streaming; and
a main unit controller controlling signals exchanged between internal elements to control the play of an audio material from the mobile terminal and remotely controlling the mobile terminal.

11. The stereo support system of claim 10, wherein the main unit controller transmits a play control command to the mobile terminal for a remote control of sound reproduction and a call control command to the mobile terminal for a call processing.

12. The stereo support system of claim 8, wherein the sound generation sub-unit comprises:
a sub wireless module establishing a short-range wireless channel to the mobile terminal;
a sub audio processor;
a sub key input section generating a key signal to control an audio streaming; and
a sub unit controller controlling signals exchanged between internal elements to control the play of an audio material from the mobile terminal.

13. The stereo support system of claim 8, wherein the control unit streams the first audio material to the sound generation main unit and the second audio material to the sound generation sub-unit such that streaming timing of the first audio material is different from that of the second audio material by a preset time interval.

14. The stereo support system of claim 9, wherein the control unit establishes a connection-oriented communication channel to the sound generation main unit for the first audio material, another connection-oriented communication channel to the sound generation sub-unit for the second audio material, and a connectionless communication channel to the sound generation main unit for a remote control command to control play of the first audio material.

15. The stereo support system of claim 9, wherein the control unit suspends, in response to a reception of an incoming call, streaming of the first audio material and second audio material, establishes a call connection under the control of the sound generation main unit, forwards an incoming voice signal related to the incoming call to the sound generation device for sound generation, and transmits an outgoing voice signal collected from a user to the calling party.

16. The stereo support system of claim 9, wherein the control unit establishes, in response to a reception of an incoming call, a connectionless communication channel to the sound generation main unit for call control by the sound generation main unit, a connection-oriented communication channel to the sound generation main unit for voice transmission, and a connection-oriented communication channel to the sound generation sub-unit for voice transmission.

17. The stereo support system of claim 9, wherein the control unit creates, in response to a reception of a stereo support cancel request message from the sound generation main unit, a stereo support cancel conform message, transmits the stereo support cancel conform message to the sound generation main unit and the sound generation sub-unit, and terminates streaming of the first audio material to the sound generation main unit and of the second audio material to the sound generation sub-unit.

18. The stereo support system of claim 9, wherein the control unit creates, in response to a reception of a stereo support cancel key signal input through a key input unit, a stereo support cancel conform message, transmits the stereo support cancel conform message to the sound generation main unit and sound generation sub-unit, and terminates streaming of the first audio material to the sound generation main unit and of the second audio material to the sound generation sub-unit.
